(19) United States
(12) Patent Application Publication
(10) Pub. No.: US 2012/0321371 A1
(43) Pub. Date: Dec. 20, 2012

(54) FASTENER MECHANISM

(76) Inventor: Preben Fritzboeger, Helsinge (DK)

(21) Appl. No.: 13/511,327

(22) PCT Filed: Nov. 18, 2010
(86) PCT No.: PCT/DK2010/050311

§ 371 Date: Sep. 4, 2012

(30) Foreign Application Priority Data
Nov. 23, 2009 (DK) BA 2009 00195

(51) Int. Cl. E03F 7/00; F16L 55/00

(52) U.S. Cl. 403/23

(57) ABSTRACT

The invention relates to a fastener mechanism, optionally comprising a shield. The fastener mechanism is intended for use in preferably cylindrical cavities, such as sewers. It comprises adjustable engagement means for engagement with the inner sides of the cavity; and an activation unit for adjusting the engagement means to the effect that they can be adjusted between a first position in which they are in engagement with the inner sides of the cavity, and a second position in which the engagement means allow introduction of the fastener mechanism into the cavity.

The invention relates to a fastener mechanism, optionally comprising a shield, for use in preferably cylindrical cavities, said fastener mechanism comprising: adjustable engagement means for engagement with the inner sides of the cavity, an activation unit for adjusting the engagement means to the effect that they can be adjusted between a first position in which the engagement means are able to engage with the inner sides of the cavity, and a second position in which the engagement means allow introduction of the fastener mechanism into the cavity.

When equipment is to be mounted in sewers, it is accomplished by the prior art in that a compressed, elastic shield is introduced into the sewer, following which it is released and resiliently engages the sides of the pipe. It is in the nature of things that they have an engagement force which depends on the elasticity/the spring force. However, it has been found that, in particular circumstances, it may be advantageous to be able to adjust the engagement force, and the invention has enabled this.

According to the invention it is enabled in that the engagement means comprise two side elements that are hinged to each other to the effect that the angle there between can be adjusted; and that the activation mechanism comprises a pull means extending between those two side elements in such a manner that a pull in that pull means entails that a force/moment is applied to the side elements which acts thereon in the direction away the second position to the first position to the effect that the engagement means are able to engage with the inner sides of the cavity.

Hereby a fastening of hitherto unknown strength is accomplished.

Embodiments of this invention will appear from the subclaims.

In the following, an exemplary embodiment of the invention will be described with reference to the figures.

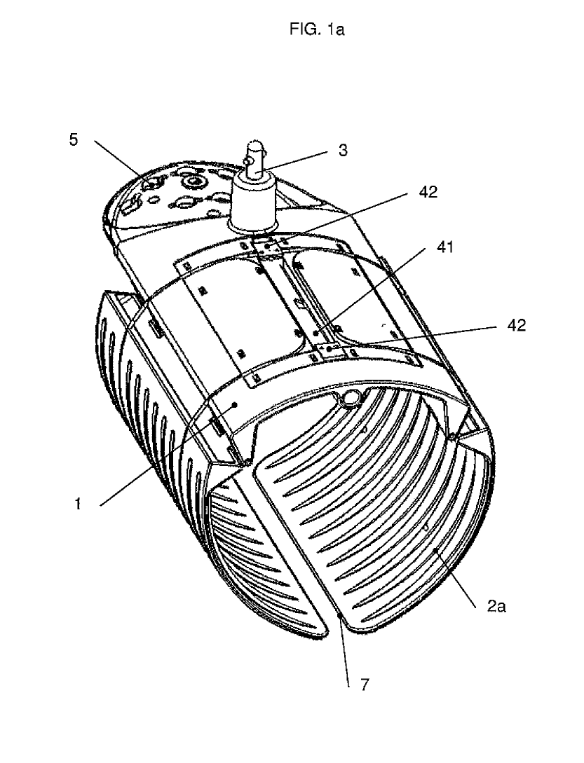

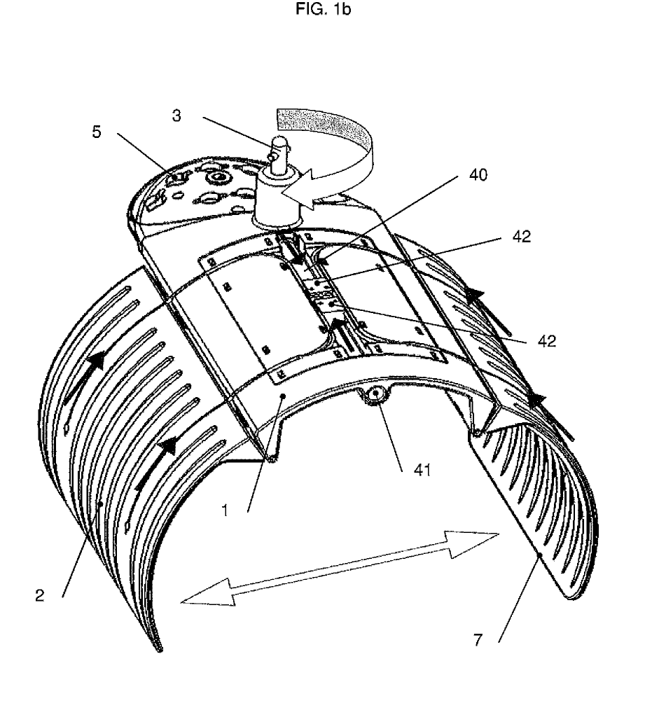

FIG. 1a shows an exemplary embodiment of a fastener mechanism according to the invention, in a folded state;

FIG. 1b shows an exemplary embodiment of a fastener mechanism according to the invention, in an unfolded state;

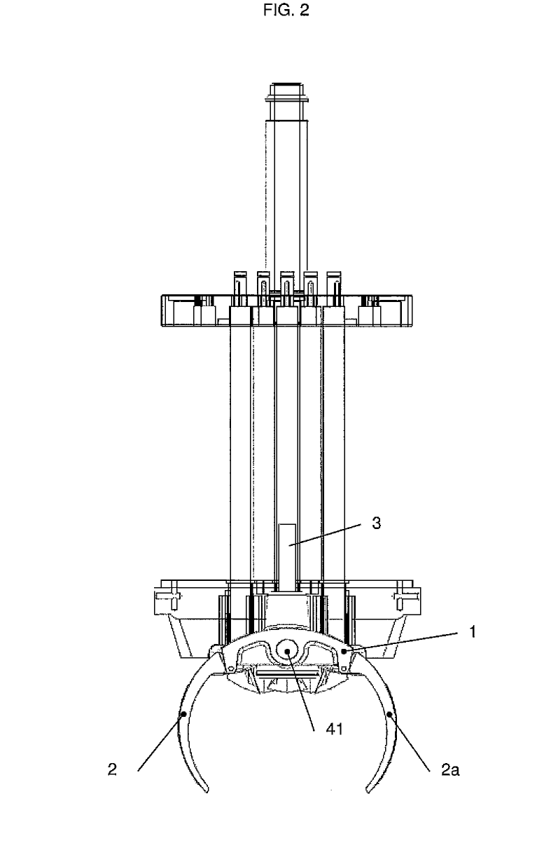

FIG. 2 shows, seen from the one side, a fastener mechanism with two side elements which are assembled via a shield;

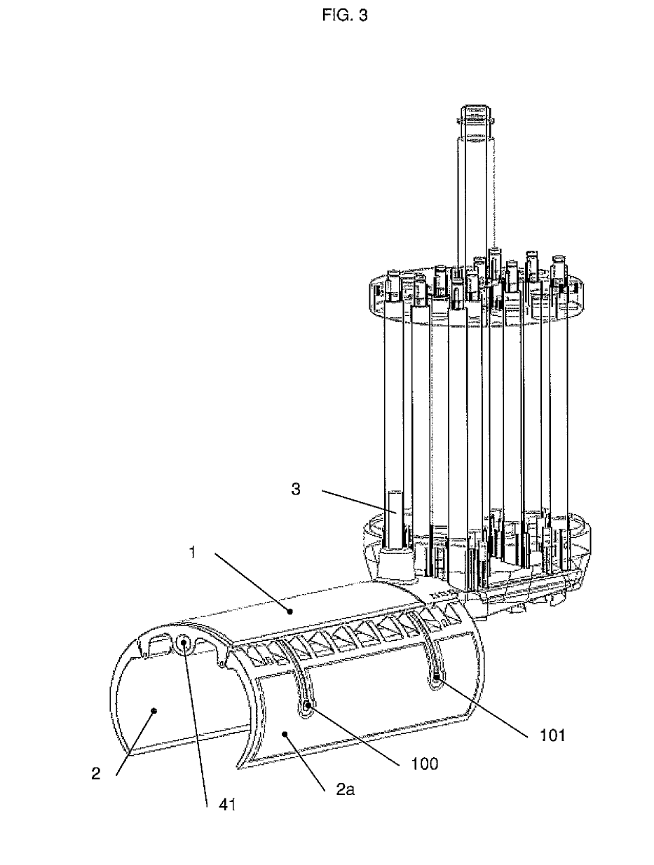

FIG. 3 is a perspective view of a fastener mechanism with a rat trap mounted.

FIGS. 2 and 3 show an assembled fastener mechanism, seen from the one end. The shown fastener mechanism comprises engagement means that are constituted by curved side elements. The fastener mechanism comprises an activation unit (42, 41, 3) that can move the side elements (2, 2a) between a position in which the side elements are in engagement with the inner sides of a cavity and a position in which the fastener mechanism can be mounted (introduced) into the cavity which is preferably a sewer pipe. In the shown embodiment, the engagement means consist of two side elements (2, 2a) that are hinged onto a third side element (1) (in the following designated ‘shield’) to the effect that the angle between the side elements and the shield can be adjusted. For use to that end, the unit is provided with a pull mechanism extending between shield and side element(s) in such a manner that an increased pull therein entails that the angle between side element(s) and shield is increased. In FIG. 3, an embodiment of the pull mechanism is shown. Therein, the pull is made by means of two strings (101, 100) extending on the outside of the side elements (the convex part). As will appear, the side elements of this and all other depicted embodiments are made with curved sides (2, 1, 2a). This is due to the fact that the fastener mechanism is preferably to be mounted in curved pipes (sewer pipes), but—where that is not the case—one may very well configure the side elements/shield of the fastener mechanism in another way, eg as right or straight faces.

FIGS. 1a and 1b show a fastener mechanism according to the invention in a folded and an unfolded state, respectively. As will appear from the figures, the side elements are usually (but not necessarily) joined via a so-called shield (1). As will appear from FIG. 2, the side elements can be constituted of two curved screens that are mounted (hinged) via the curved shield (1). The reason for this shape is—in that embodiment—that the convex parts of the side elements and the shield are intended for engaging with the inner side of a cylindrical pipe (sewer pipe).

Onto the shield (1), various apparatuses can be fastened, eg a rat trap as described in Danish patent application No. PA20090001357.

On the fastener mechanism shown in FIG. 1, an activation mechanism (40) is built integrally with the shield (1), which mechanism is used to adjust the angles on the side elements (2). In the shown example, the activation mechanism (40) comprises a spindle (41), on which two carriages (42) are mounted. Carriages (42) are in threaded engagement with the spindle such that a rotation of the spindle brings about a movement of the carriages. The thread on the spindle can be selected to be configured such that the carriages are pulled towards or away from each other upon rotation of the spindle. The thread can also be continuous throughout the entire spindle to the effect that the carriages are moved in the same direction when the spindle is rotated. The thread of the spindle can of course also be configured with varied pitch (of course mutually adapted to that of the carriages) to the effect that (in a unit with a plurality of carriages) the carriages can be moved at individual speeds.

The carriages are connected to strings (not shown) that extend essentially on the outside of the side elements (2, 2a), which is, in the exemplary embodiment shown, the convex side of the engagement means. In the shown exemplary embodiments of the invention, the engagement means (2, 2a) are each separately provided with two string drives (100, 101) as will appear from FIG. 3, but in principle it can be varied and it is within the competence of the person skilled in the art to adapt that number in accordance with the needs for specific tasks.

In the shown embodiment, the spindle is coupled to a connection coupling via a gearbox with eg gear wheels with helical teeth such as crown pinions mounted on the connection coupling (3) and the spindle (41), respectively. The arrangement can, of course, be made in other ways that will be obvious to the person skilled in the art, eg by means of ball joints or the like.

On the top face of the shield, mounting apertures (5) are provided that can be used for mounting of a device, such as eg a rat trap.

As mentioned above, the fastener mechanism is operated in that the adjustable engagement means (2) can be angled relative to the shield (1), as the distance between the lower edges (7) of the side elements thereby remains unchanged. The lower edge (7) is best shown in FIG. 1 and is the free edge of the engagement means opposite the edge fastened to the shield (1). By adjustment of the distance between the lower edge of the side elements, the fastener mechanism can be secured in a given cavity, the side elements and the shield (1, 2, 2a) pressing against the walls of the cavity and in that way wedging the fastener mechanism in place.

As explained above, the engagement means (2) are set by means of a string drive (100, 101) connected thereto (2). Functionally, the string drive (100, 101) operates by the strings being arranged on the outside of the fastener mechanism, ie the side that faces towards the angle of more than 180 degrees between the two side elements (or, in case the side elements are curved, the convex part). The string drive is activated by two carriages (42) mounted on a spindle (41). When the spindle (41) rotates the one way, the carriages (42) move towards each other and pull the strings, and thereby the engagement means (2) are forced outwards. When the spindle (41) rotates the opposite way, the carriages (42) move away from each other, and the string drive is loosened, and the distance between the lower edges (7) of the engagement means (7) is reduced. According to one embodiment of the invention, the side elements and the shield can be made to be elastic to the effect that the lower edges of the side elements seek towards each other by themselves when the strings are slackened. Albeit a string drive is described herein, the string drive is not in itself, however, essential as the invention can also be used with other pull devices of which the person skilled in the art is fully aware, such as bands, chains or the like.

The pull may even be established by means of an elastic band or the like resilient element extending on the outside of the side elements. Thereby the fastener mechanism can be made in a simple form where the spindle solution or other mechanical solutions can be obviated altogether; should one desire to vary the retainment force, one merely replaces such elastic means by other elastic means having higher or lower spring force.

As will appear from FIG. 3, the invention may be provided with a connection coupling (3) that cooperates with the spindle in such a way that the spindle (41) is rotated by rotation of the connection coupling (3), and purely functionally this is accomplished in the shown embodiment in that a rotation about an axis in parallel with the connection coupling is transferred to a perpendicular axis in parallel with the spindle (41). This is particularly suitable when the fastener device is used for mounting of rat traps in sewer pipes in that the trap is simply lowered into a well with inlet or outlet openings from sewer pipes, following which a part of the fastener mechanism is inserted into one of those pipes. As will appear most clearly from FIG. 3, spindle/connection coupling enables that the fastener mechanism can be configured (with a rat trap mounted) such that it can be inserted in almost its entire length while still retaining the connection coupling (the mounting platform) in the clear to the effect that it can be operated (from above) and thereby cause the side elements to be in engagement with the sides of the pipe. In usual circumstances, the fastener mechanism is operated by means of a rod which is pressed down on and in engagement with the connection coupling. Of course, rod and coupling can be adapted to each other such that the moments can be transferred (eg by means of a notch or the like). The advantage of such arrangement is that it is thereby possible to mount the fastener mechanism in a sewer well without the fitter necessarily having to enter the well, him/her merely lowering the fastener mechanism into the well (optionally by means of the rod for the coupling) and inserting it into one of the pipes connected tot eh pipe, following which the rod (which is, of course, to be of a suitable length) is rotated until the fastener mechanism is secured with desired strength. Between the connection coupling (3) and the spindle, it is possible to integrate a coupling for the purpose of preventing overload of or locking of the system. According to a particular embodiment, the coupling is integrated into the shaft as such between the connection coupling and the gear wheel (6).

According to one embodiment of the invention, the engagement means comprise a friction-increasing coating placed on the outside of the side elements. Thereby a more wear-resistant construction is obtained and/or a stronger fastening. The coating may eg be a rubber coating or a plastics coating.

Albeit all the figures show a fastening unit comprising or presupposing the use of a shield, it is obvious, however, that it is also possible to produce a fastener mechanism which merely comprises two side elements or shields which are provided with a pull mechanism/string/elastic band on their outside/convex part.

Albeit the fastener mechanism was explained in terms of a manually operated fastener mechanism, however, it is obvious that, of course, it can be driven by an electromotor, and such arrangement can also be remote-controlled. The fastener mechanism can be made from plastics material.

The scope of protection is not limited to the exemplary embodiments shown in the figures; rather it is defined by the claims.

1. A fastener mechanism, comprising a shield, for use in preferably cylindrical cavities, said fastener mechanism comprising:
adjustable engagement means for engagement with inner sides of a cavity;
an activation unit for adjusting the engagement means to facilitate adjustment between a first position, in which the engagement means are able to engage with the inner sides of the cavity, and a second position in which the engagement means allow introduction of the fastener mechanism into the cavity,
characterized in that the engagement means comprise two side elements that are hinged onto a shield to facilitate adjustment of an angle between the side elements and the shield; and that the activation mechanism comprises a pull mechanism extending between shield and side elements in such a manner that an increased pull therein entails that the angle between side elements and shield is increased, whereby the engagement means are able to engage with the inner sides of the cavity.

2. A fastener mechanism according to claim 1, characterized in said engagement means having a lower edge being a free edge of the engagement means opposite the edge fastened to the shield.

3. A fastener mechanism according to claim 1, characterized in that the activation means comprises one or more carriages arranged on a spindle.

4. A fastener mechanism according to claims 1, characterized in that the fastener mechanism comprises a shield mounted between two side elements.

5. A fastener mechanism according to claim 4, characterized in that the fastener mechanism comprises a shield adapted such that a rat trap can be mounted thereon.

6. A fastener mechanism according to claim 3, characterized in that the activation means comprises one or more carriages arranged on a spindle, wherein the one or more carriages and spindle are arranged in the shield.

7. A fastener mechanism according to claim 1, characterized in that the pull mechanism comprises a string arranged on the outside of the side elements.

8. A fastener mechanism according to claim 1, characterized in that the pull mechanism comprises a string arranged between the sides and the shield on the outside thereof.

9. A fastener mechanism according to claim 1, characterized in that the engagement means comprise a friction-increasing coating.

10. A fastener mechanism according to claim 2, characterized in that the activation means comprises one or more carriages arranged on a spindle.

11. A fastener mechanism according to claim 2, characterized in that it comprises a shield mounted between two side elements.

12. A fastener mechanism according to claim 3, characterized in that it comprises a shield mounted between two side elements.

13. A fastener mechanism according to claim 2, characterized in that the pull mechanism comprises a string arranged on the outside of the side elements.

14. A fastener mechanism according to claim 3, characterized in that the pull mechanism comprises a string arranged on the outside of the side elements.

15. A fastener mechanism according to claim 4, characterized in that the pull mechanism comprises a string arranged on the outside of the side elements.

16. A fastener mechanism according to claim 2, characterized in that the pull mechanism comprises a string arranged between the sides and the shield on the outside thereof.

17. A fastener mechanism according to claim 3, characterized in that the pull mechanism comprises a string arranged between the sides and the shield on the outside thereof.

18. A fastener mechanism according to claim 4, characterized in that the pull mechanism comprises a string arranged between the sides and the shield on the outside thereof.

19. A fastener mechanism according to claim 2, characterized in that the engagement means comprise a friction-increasing coating.

20. A fastener mechanism according to claim 3, characterized in that the engagement means comprise a friction-increasing coating.
